(19) United States
(12) Patent Application Publication
(10) Pub. No.: US 2024/0372902 A1
(43) Pub. Date: Nov. 7, 2024

(54) Metaverse Implementation Method

(71) Applicant: WALTON ADVANCED ENGINEERING INC., Kaohsiung (TW)

(72) Inventors: HONG CHI YU, Kaohsiung (TW); MAO TING CHANG, Kaohsiung (TW)

(21) Appl. No.: 18/647,133

(22) Filed: Apr. 26, 2024

(30) Foreign Application Priority Data
May 5, 2023 (TW) 112116685

(51) Int. Cl. H04L 65/40; G06Q 20/10

(52) U.S. Cl. CPC H04L 65/40; G06Q 20/10

(57) ABSTRACT

This invention relates to a Metaverse Implementation Method, used to facilitate interactions, information sharing, and financial transactions among users in the Virtual World. This method comprises: user devices connecting to the Metaverse Network through Private Communication Boxes; devices being registered at the Backend Name Resolver to interact with the Virtual World; influences of the users in the Virtual World being recorded on Persistent Data Recording Servers; utilizing the Onion Network to facilitate message exchanges between devices. When transactions occur, the Payment Proxy Server is utilized to manage fund storage and transfer, employing encryption technology and smart contracts to ensure transaction security, fairness, and transparency. Moreover, this method supports a variety of payment methods and diverse application scenarios, enhancing the appeal and application value of the Metaverse.

### FIELD OF THE INVENTION

This invention pertains to the field of e-commerce and virtual world technologies, specifically relating to a method of execution based on a Metaverse environment. This method is employed to realize interactivity, information sharing, and financial transactions between users while ensuring transactional security, fairness, and transparency. This method is applicable in various scenarios such as entertainment, education, business, and social interactions. It supports multiple payment methods, effectively enhancing the appeal and application value of the Metaverse.

### DESCRIPTION OF THE PRIOR ART

Virtual worlds typically encompass one or more online platforms supporting user interactions, communications, gaming, and other activities. However, traditional virtual world technologies possess certain limitations, such as limited capability for information sharing, cumbersome and insecure financial transaction processes, and barriers to user interaction across different platforms.

To address these challenges, several solutions have emerged, such as utilizing third-party payment tools for financial transactions in the virtual world and enabling interactions between different platforms through online services. However, these solutions still exhibit certain limitations, like insufficient assurance in the security, fairness, and transparency of transactions, and language communication barriers among users.

Furthermore, traditional virtual world technologies often rely on centralized servers, potentially leading to single-point failures in information storage and processing, thus reducing system scalability and stability. In this context, developing a method based on the Metaverse holds significant value, overcoming the limitations of traditional virtual world technologies and enabling efficient interactions, information sharing, and financial transactions among users.

In literature pertaining to virtual worlds, multiple patents are as follows:

U.S. Patent U.S. Pat. No. 6,219,045B1 discloses a highly scalable architecture for 3D graphics, multi-user, interactive virtual world systems. Multiple users can interact within a 3D computer-generated graphical space, with each user executing a client process to observe the virtual world from their perspective. The virtual world displays avatars representing neighboring users, who are viewing the virtual world. To update views reflecting the movement of remote user avatars, motion information is transmitted to a centralized server, providing position updates for the neighboring clients of this client process.

U.S. Patent U.S. Pat. No. 10,967,255B2 discloses a system for offering a virtual reality system, specifically a game simulation hybrid, providing a vast online virtual world and corresponding network based on user profiles, events, activities, challenges, virtual lifestyles, and advertisements. This system presents digital versions of live events or activities on user computing devices, enabling users to actively participate in live events or activities happening at remote locations.

Chinese Patent CN113946211A discloses a method and related equipment for interaction among multiple objects based on the Metaverse. The method includes obtaining real-time interaction information of a first object in the real world and generating corresponding virtual data for a first virtual object in a virtual scene. This virtual object corresponds to the first object. The method also involves outputting this virtual data to a second object in the real world, obtaining real-time interaction information from this second object regarding the first virtual data, and outputting corresponding feedback information to the first object based on this interaction.

In summary, U.S. Patent U.S. Pat. No. 6,219,045B1 introduces a highly scalable architecture for 3D graphics and multi-user, interactive virtual world systems. U.S. Patent U.S. Pat. No. 10,967,255B2 presents a system for offering a virtual reality system, focusing on presenting live events or activities in the virtual world and ways users interact within this virtual space. Chinese Patent CN113946211A discusses converting real-world objects into virtual counterparts within a virtual scene and realizing real-time interaction between these virtual and real-world entities. While these patents cover several facets of virtual world technologies, aspects like financial transactions, language translation, diverse services, data exchange security, and decentralized communication remain vital areas of ongoing research.

### [Invention Content]

In view of the above problems, the present invention provides a metaverse implementation method, through the private communication box and the metaverse network, providing users with higher interactivity and security in the metaverse network, ensuring privacy protection and reducing potential risks.

Another objective of this invention is to provide a metaverse implementation method that supports the operation of payment intermediary servers within the metaverse network, realizing the simplification and automation of financial transaction processes in the virtual world, improving transaction efficiency.

Another objective of this invention is to provide a metaverse implementation method that, under the artificial intelligence language translation service, enhances the interactivity between users across different languages, expanding the diversified applications of the metaverse.

Another objective of this invention is to provide a metaverse implementation method where incorporating other services into the virtual world will have a rich application scene, including but not limited to entertainment, education, business, social fields, meeting the diverse needs of users in the metaverse, enhancing the appeal and application value of the metaverse.

Another objective of this invention is to provide a metaverse implementation method that enhances data transmission security and privacy protection through the onion network, reducing the impact of a single node failure on the overall network.

Another objective of this invention is to provide a metaverse implementation method that, through a decentralized architecture and the use of blockchain technology, ensures the security and immutability of data storage in the virtual world, enhancing the reliability and security of data storage, protecting the rights and interests of users in the metaverse.

Another objective of this invention is to provide a metaverse implementation method that supports various payment methods through the payment intermediary server, meeting the diverse payment needs of users, enhancing the convenience and internationalization of transactions within the metaverse.

Another objective of this invention is to provide a metaverse implementation method where the payment intermediary server uses smart contract technology to ensure the fairness and transparency of transactions.

To achieve the above objectives, the main technical means used by the present invention is to adopt the following technical solutions. The invention is a metaverse implementation method, which includes the following steps: step a: connecting a first user device to a metaverse network through a first private communication box; step b: registering the first user device in a first backend name resolver in the metaverse network, enabling the first user device to interact with a virtual world in the metaverse network; step c: the influence of the first user device in the virtual world will be recorded on a first persistent data recording server; step d: the first user device exchanges messages with a second user device in the virtual world through an onion network.

The objectives of this invention and the solution to its technical problems can also be further realized using the following technical measures.

The aforementioned method, wherein after step d, when a transaction occurs, the first user device can deposit funds into a payment intermediary account through a payment intermediary server, and then the payment intermediary server transfers the funds to a designated account of the second user device.

The aforementioned method, wherein an artificial intelligence language translation service can be registered in the first backend name resolver, providing message exchange conversion between the first user device and the second user device.

The aforementioned method, wherein the onion network is composed of multiple nodes and implements communication between nodes through anonymous forwarding, ensuring decentralized and dispersed data exchange.

The aforementioned method, wherein a second persistent data recording server and a second backend name resolver can be registered in the first backend name resolver, making the information of the first backend name resolver and the second backend name resolver consistent with each other.

The aforementioned method, wherein the payment intermediary server supports various payment methods, including but not limited to credit cards, mobile payments, etc.

The aforementioned method, wherein the payment intermediary server uses encryption technology to ensure the security during the transaction process, preventing sensitive information from being illegally altered or leaked.

The aforementioned method, wherein the payment intermediary server uses smart contract technology to ensure the fairness and transparency of transactions, preventing fraud and other issues.

Compared with the prior art, the invention has the effect of: (1) providing users with higher interactivity and security in the metaverse network, ensuring privacy protection and reducing potential risks; (2) realizing the simplification and automation of financial transaction processes in the virtual world, improving transaction efficiency; (3) enhancing the interactivity between users across different languages, expanding the diversified applications of the metaverse; (4) ensuring the security and immutability of data storage in the virtual world, enhancing the reliability and security of data storage, protecting the rights and interests of users in the metaverse.

### BRIEF DESCRIPTIONS OF THE DRAWINGS

FIG. 1 is the flowchart of the first embodiment of the invention.

FIG. 2 is the flowchart of the second embodiment of the invention.

FIG. 3a is the schematic diagram of step a in the preferred embodiment of the invention.

FIG. 3b is the schematic diagram of step b in the preferred embodiment of the invention.

FIG. 3c is the schematic diagram of step c in the preferred embodiment of the invention.

FIG. 3d is the schematic diagram of step d in the preferred embodiment of the invention.

FIG. 4a is the first schematic diagram of the Metaverse Network in the preferred embodiment of the invention.

FIG. 4b is the second schematic diagram of the Metaverse Network in the preferred embodiment of the invention.

FIG. 5 is the schematic diagram of step e in the preferred embodiment of the invention.

### DETAILED DESCRIPTIONS OF THE PREFERRED EMBODIMENTS

In order to make the objectives, features, and effects of this invention clearer, the following particularly lists a preferable embodiment of this invention:

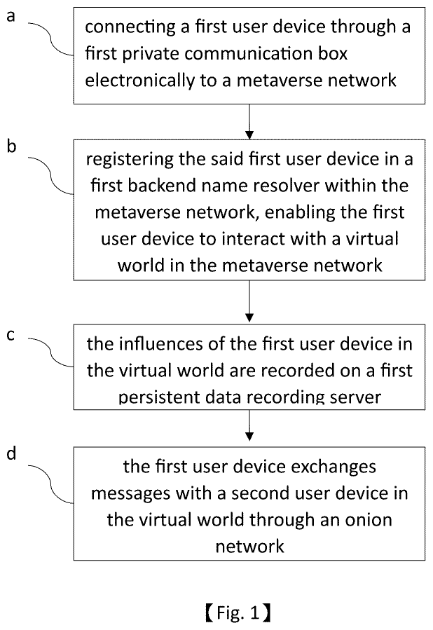

As shown in FIG. 1, the invention relates to a high-security network message transmission method of the first embodiment: Firstly, refer to the flowchart of FIG. 1, mainly consisting of step a (a), step b (b), step c (c), and step d (d).

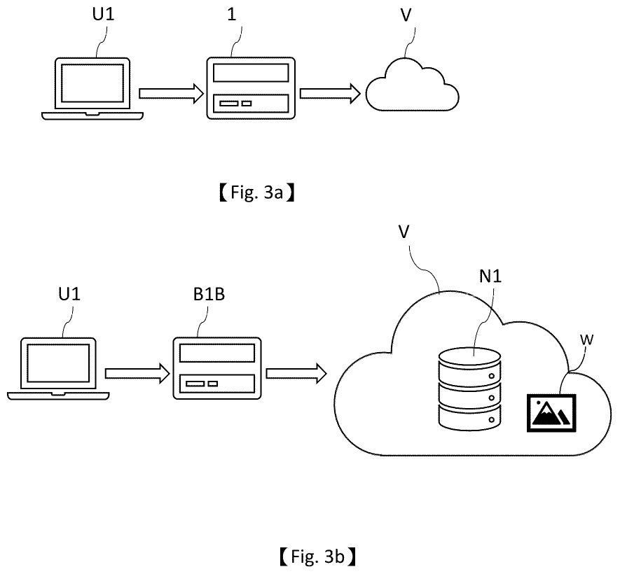

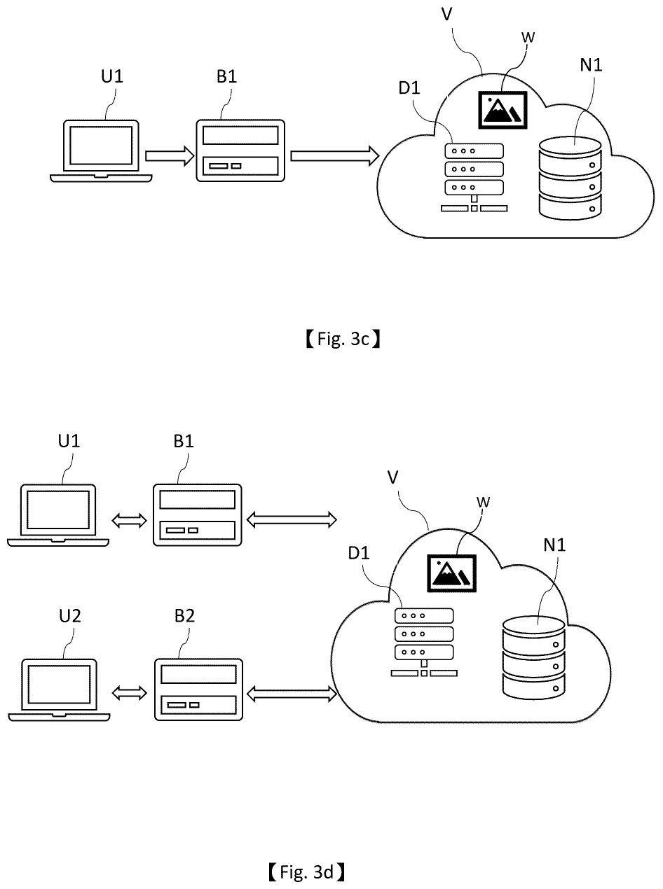

As illustrated in FIG. 1 and FIG. 3a, step a (a) involves a first user device (U1) electrically connecting to a metaverse network (V) through a first private communication box (B1).

Specifically, the role of step a (a) in the metaverse execution method is to establish a connection, ensuring the user can correctly enter and interact with the virtual world; the first user device (U1) refers to a client device used for interacting with the metaverse network. This device can be any smart device with network connectivity and running the corresponding software, such as smartphones, tablets, laptops, or desktop computers. In the metaverse, the first user device is the main tool for users to interact with the virtual world. The first private communication box (B1) in the metaverse execution method serves as a secure relay device, facilitating the establishment of a secure electrical connection between the first user device (U1) and the metaverse network (V).

Next, referring to FIG. 1 and FIG. 3b, step b (b) involves logging the first user device (U1) onto a first backend name resolver (N1) within the metaverse network (V), enabling the first user device (U1) to interact with a virtual world (W) of the metaverse network (V).

The role of step b (b) in the metaverse execution method is to log the first user device (U1) into the first backend name resolver (N1) within the metaverse network. The main purpose of this step is to ensure that the first user device (U1) can smoothly interact with the virtual world (W) of the metaverse network (V). The first backend name resolver (N1) manages and maintains resource and service mappings within the metaverse network. It's responsible for associating user identification information of the first user device (U1) and other relevant user devices (e.g., IP addresses, usernames) with the corresponding resources and services in the metaverse network (V).

Subsequently, as depicted in FIG. 1 and FIG. 3c, step c (c) involves recording the influence of the first user device (U1) in the virtual world (W) on a first persistent data recording server (D1).

The role of step c (c) in the metaverse execution method is to ensure that the operations and interactions of the first user device (U1) in the virtual world (W) are properly recorded and saved. This means that the behaviors, changes, and transactions such as virtual assets, transaction records, and behavioral history of users in the virtual world (W) are recorded for later inquiry and analysis, ensuring the continuity and stability of the virtual world (W). The first persistent data recording server (D1) plays a key role in this process, being responsible for storing and managing all data related to the interactions and operations of the first user device (U1) in the virtual world (W). This data might include users' virtual assets, transaction histories, behavioral patterns, etc. By storing these data in the first persistent data recording server (D1), data security and reliability are ensured, offering quick access when needed. Moreover, the first persistent data recording server (D1) can collaborate with other related data recording servers to ensure data consistency and real-time information in the virtual world.

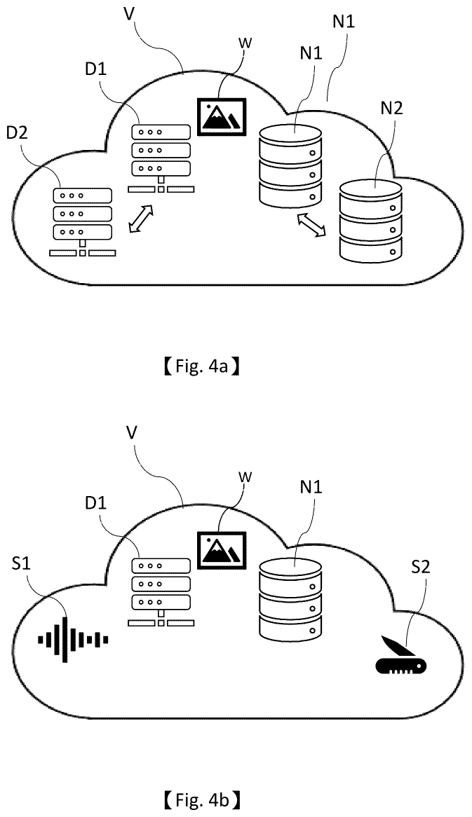

Preferably, as shown in FIG. 4a, a second persistent data recording server (D2) and a second backend name resolver (N2) can be registered in the first backend name resolver (N1), ensuring the consistency of information between the first backend name resolver (N1) and the second backend name resolver (N2). The benefits of this approach include: 1. Data Consistency: By keeping the information of the first backend name resolver (N1) and the second backend name resolver (N2) consistent, data throughout the metaverse system remains consistent. This helps in reducing data discrepancies and ensuring smooth user interactions and behaviors in the virtual world (W).2. Load Balancing: By distributing requests among multiple backend name resolvers, system load is balanced, enhancing the overall performance and response time of the metaverse system.3. High Availability: If one backend name resolver fails or malfunctions, others can continue to provide services, ensuring uninterrupted user experience in the virtual world.4. Fault Tolerance: Keeping backend name resolver information consistent aids in enhancing system fault tolerance. This ensures quick recovery from errors and continued stable services.

Lastly, as depicted in FIGS. 1 and 3d, step d (d) is for the first user device (U1) in the virtual world (W) to exchange messages with a second user device (U2) via an onion network (T).

The role of step d (d) in the metaverse execution method is to ensure secure, private, and decentralized information exchange between the first user device (U1) and the second user device (U2). During this process, both user devices can interact within the virtual world (W), such as having conversations, transactions, or participating in activities together. The onion network (T) plays a significant role here, employing onion routing, where messages are encapsulated in layers like an onion and transmitted through a series of nodes called onion routers. As each packet passes through an onion router, the outermost layer gets decrypted until the final layer is decrypted at the destination. This ensures that each node, including the destination, only knows the previous node's location, but not the entire transmission path or the original sender's address, making tracking and monitoring extremely challenging. In the metaverse execution method, the onion network (T) ensures the private, decentralized, and distributed characteristics of the information exchange between the first user device (U1) and the second user device (U2), reducing the risk of data theft or tampering. The role of the second user device (U2) in this process is to act as an interacting object for the first user device (U1) in the virtual world (W). The second user device (U2) can be another user's device, or a virtual character or entity. Through interaction with the second user device (U2), the first user device (U1) can establish relationships, exchange information, participate in activities, and conduct transactions in the virtual world, thereby enhancing the immersion and user experience in the virtual world.

Preferably, as described in FIG. 4b, an artificial intelligence language translation service (S1) and other services (S2) can be registered in the first backend name resolver (N1), facilitating cross-language communication between the first user device (U1) and the second user device (U2). Given that users in the virtual world (W) may come from different linguistic backgrounds, the artificial intelligence language translation service (S1) can instantly translate messages from one side to a language understandable by the other, thereby eliminating language barriers and promoting cross-linguistic and cross-cultural communication. The other service (S2) generically refers to other services provided in the metaverse, including gaming services, social services, virtual store services, and educational services, adding to the richness and functionality of the virtual world (W).

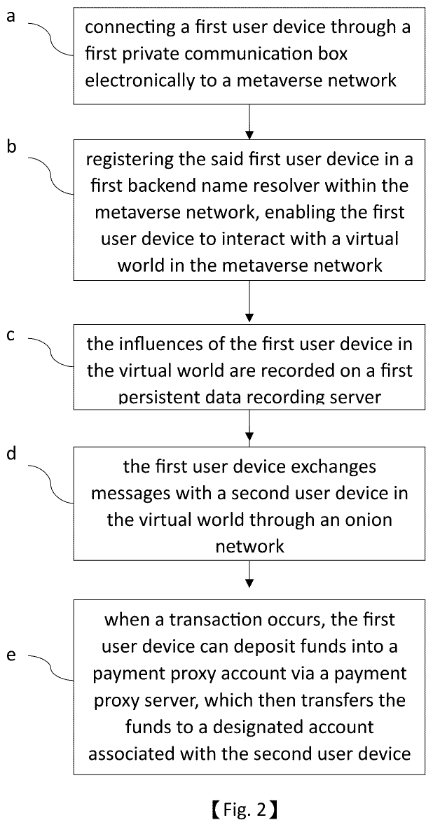

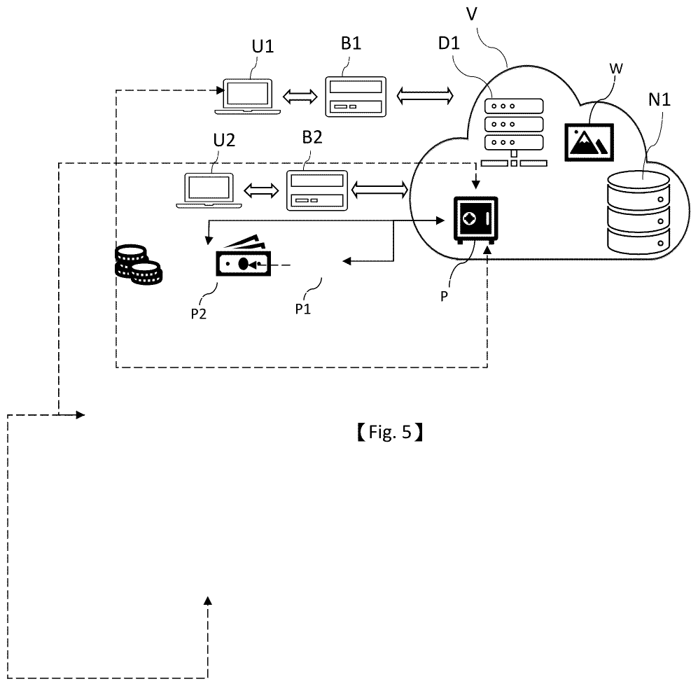

Further reference is made to FIGS. 2, 3a, 3b, 3c, and 5, illustrating a second embodiment of the metaverse implementation method of this invention. Features identical to those described in the first embodiment and shown in FIGS. 1, 3a, 3b, and 3d are indicated with the same reference symbols or omitted in FIGS. 2 and 5 to avoid redundancy. The primary distinction between the second embodiment and the first embodiment lies in the addition of step e (e) in the latter.

The flowchart of the second embodiment, as shown in FIG. 2, includes steps a (a), b (b), c (c), d (d), and e (e). Steps a (a), b (b), c (c), and d (d) have been described in detail in the first embodiment and are not elaborated upon here.

Furthermore, referring to FIG. 2 for step e (e) and FIG. 5, after step d (d), when a transaction occurs, the first user device (U1) can deposit funds into a payment proxy account (P1) through a payment proxy server (P), which then transfers the funds to a designated account (P2) of the second user device (U2).

Step e (e) elucidates a method of realizing financial transactions in the metaverse, offering users the ability to buy and sell goods, services, etc., within the virtual world. This enhances the interactivity and attractiveness of the metaverse and meets users' financial activity needs in the virtual world. The payment proxy server (P) is responsible for processing the financial transactions within the metaverse, connecting to the payment proxy account (P1) and designated account (P2), ensuring that funds are securely and swiftly transferred between accounts during user transactions.

Preferably, the payment proxy server (P) supports various payment methods, including but not limited to credit cards and mobile payments, and multiple currencies like USD, EUR, and CNY. It addresses users' diverse payment needs, enhancing the convenience and internationalization of transactions within the metaverse. Moreover, encryption technologies are employed on the payment proxy server (P) to ensure transaction security, preventing unauthorized alterations or data breaches. The use of smart contracts further guarantees the fairness and transparency of transactions, eliminating the potential for fraudulent activities.

Therefore, the effectiveness of the present invention is distinct from regular metaverses, being pioneering in terms of online privacy and security. It meets the requirements for a patent application and is hereby submitted for approval.

It must be reiterated that the above descriptions are merely preferable embodiments of the present invention. All equivalent variations applied in accordance with the present specification, patent claims, or drawings still fall within the technical scope protected by this invention. Hence, any changes or modifications based on the present invention should not be deemed as being outside of the invention's scope.

What is claimed is:

1. A Metaverse Implementation Method comprising the following steps:
Step a: connecting a first user device through a first private communication box electronically to a metaverse network;
Step b: registering the said first user device in a first backend name resolver within the metaverse network, enabling the first user device to interact with a virtual world in the metaverse network;
Step c: the influences of the first user device in the virtual world are recorded on a first persistent data recording server;
Step d: the first user device exchanges messages with a second user device in the virtual world through an onion network.

2. The metaverse implementation method according to claim 1, wherein after step d, when a transaction occurs, the first user device can deposit funds into a payment proxy account via a payment proxy server, which then transfers the funds to a designated account associated with the second user device.

3. The metaverse implementation method according to claim 1, wherein an artificial intelligence language translation service can be registered in the first backend name resolver, facilitating the conversion of message exchanges between the first and second user devices.

4. The metaverse implementation method according to claim 1, wherein other services can be registered in the backend name resolver.

5. he metaverse implementation method according to claim 1, wherein the onion network comprises multiple nodes, and communication between nodes is facilitated through anonymous relaying to ensure decentralized and dispersed data exchange.

6. The metaverse implementation method according to claim 1, wherein a second persistent data recording server and a second backend name resolver can be registered in the first backend name resolver, ensuring consistency of information between the first and second backend name resolvers.

7. The metaverse implementation method according to claim 2, wherein the payment proxy server supports various payment methods, including but not limited to credit cards, mobile payments, etc.

8. The metaverse implementation method according to claim 2, wherein encryption technology is utilized in the payment proxy server to secure transactions, preventing unauthorized alteration or leakage of sensitive information.

9. The metaverse implementation method according to claim 2, wherein smart contract technology is employed in the payment proxy server to ensure fairness and transparency in transactions, preventing issues like fraud.
